(19) United States
(12) Patent Application Publication
(10) Pub. No.: US 2011/0066961 A1
(43) Pub. Date: Mar. 17, 2011

(54) METHOD AND APPARATUS FOR PRESENTING A SUMMARY OF A CONTENT ITEM

(75) Inventors: Lu Wang, Eindohoven (NL); Pedro Fonseca, Eindohoven (NL); Bastiaan Zoetekouw, Eindohoven (NL)

(73) Assignee: Koninklijke Philips Electronics N.V., Eindhoven (NL)

(21) Appl. No.: 12/992,632

(22) PCT Filed: May 18, 2009
(86) PCT No.: PCT/IB09/52049

§ 371 Date: Nov. 15, 2010

(30) Foreign Application Priority Data
May 26, 2008 (EP) 08156883.4

(51) Int. Cl. G06F 3/048

(52) U.S. Cl. 715/764

(57) ABSTRACT

A summary comprising a plurality of selected segments of the content item is presented to a user (step 202) and a user input is received (step 204). The non-selected segments located between a previously presented segment and the segment being presented at the time of receiving said user input are determined (step 206) and each non-selected segment is assigned a ranking value (step 208). At least one non-selected segment is presented (step 210). Presentation of the selected segment being presented at the time of receiving the user input is resumed (step 212).

### FIELD OF THE INVENTION

The present invention relates to a method and apparatus for presenting a summary of a content item. In particular, but not exclusively, it relates to rewinding highlights shown in a summary to present any missed highlights.

### BACKGROUND TO THE INVENTION

With the penetration of digital video into the consumer domain, many new and exciting applications are becoming possible. Consumers are no longer limited to watch broadcasts and recordings from start to end. New and innovative features make it possible to watch video in a non-linear fashion. For example, video-on-demand applications are gaining more and more momentum, and video-sharing services such as YouTube™ and Google Video™ have already gathered a huge following. Moreover, the rise of digital video opens up a huge application area for content analysis techniques.

Unfortunately, consumer-level recording devices such as Personal Video Recorders and Hard Disk Recorders have so far not seen many applications in this domain. Although some basic applications such as commercial block detection are now becoming available in hard disk recorders, the opportunities for more advanced applications seem numerous.

One of such possible applications is highlight detection for programmes such as sports programmes. Sports programmes are very popular on television, and numerous broadcasts are available every day. In fact, there are so many sports broadcasts that a modern user generally does not have enough time to watch all of them. Automatic detection of the highlights of sports games therefore appeals to many consumers.

The automatic detection of highlights in programmes enables the advantageous feature that the user can watch a “summary” of the program or, in other words, a compressed version of the entire recording which comprises only the segments that were considered as interesting (i.e. the highlights).

Although these algorithms exhibit an extremely high performance, it is practically impossible to guarantee that they will offer the user everything relevant to watch in the broadcast since they are generated automatically. Although the possibility exists for the user to use existing manual rewind or fast-backward commands on recording devices, these are extremely inconvenient and awkward in the sense that they require the user to pay full attention to the screen in order to find if the “interesting” moment that the system might have skipped is there. Moreover, they typically require the user to do this operation several times until the actual point in the recording is found.

### SUMMARY OF INVENTION

The present invention seeks to provide a method whereby rewind can be performed in a simple and efficient manner to provide the user with everything relevant to watch.

This is achieved, according to an aspect of the invention, by a method of presenting a summary of a content item, the summary comprising a plurality of selected segments of the content item, the method comprising the steps of: presenting the summary to a user; receiving a user input; presenting at least one non-selected segment located between a previously presented segment and the segment being presented at the time of receiving the user input.

This is also achieved, according to another aspect of the invention, by an apparatus for presenting a summary of a content item, the summary comprising a plurality of selected segments of the content item, the apparatus comprising the steps of: means for presenting the summary to a user; interface means for receiving a user input; means for presenting at least one non-selected segment located between a previously presented segment and the segment being presented at the time of receiving the user input.

In this way, the application remembers the current and last selected segment (or highlighted event) that the user watched. The system knows the watching context and rewinds back to events that are likely to be of interest to the user but that were skipped in the initial presented summary of the content item.

The method may further comprise the step of resuming presentation of the selected segment being presented at the time of receiving the user input, after presentation of the at least one non-selected segment.

In this way, when the auto-rewind play is over, the application resumes the play from the point where the user enabled the automatic rewind function. This provides the user with a convenient and straightforward way of watching missed highlights and automatically resuming play from the point in the program which they were at when they enabled the rewind function. Alternatively, the user can select a point in the summary from which to resume play.

The step of presenting at least one non-selected segment may comprise the steps of: presenting a first non-selected segment located after the previously presented segment; and presenting at least one subsequent non-selected segment located between the presented first non-selected segment and the segment being presented at the time of receiving said user input.

In this way, if a user notices, when being presented with a selected segment, that an important event has been missed, the user can watch the non-selected segments in order until the important event is presented. This prevents the user having to watch the non-selected segments in the wrong order as would be the case if the user went back to the non-selected segment located before the segment being presented at the time of receiving the user input and if this non-selected segment did not contain the event, going back to the non-selected segment before that and so on. This would be particularly annoying when presenting all non-selected segments between the current segment and the previously selected segment in sequence automatically. By starting with the first non-selected segment after the previously selected segment, the user can watch the non-selected segments in order even when presenting all non-selected segments between the current segment and the previously selected segment in sequence automatically.

The step of presenting at least one non-selected segment may comprise the steps of: assigning each non-selected segment of the content item a ranking value based on the user's level of interest; presenting at least one non-selected segment having a first predetermined value or having a value within a first predetermined range.

In this way, the non-selected segments which are played to the user during rewind can be tailored to a user's interests thus providing them with more relevant segments. Segments can, as a result, be ranked with different granularities or levels of interest. For example, certain segments may be ranked higher and may relate to “very interesting” segments, whereas certain other segments may be ranked lower and may relate to “less interesting but possibly still relevant” segments. In this way, the user has the ability to tailor the non-selected segments that they want presented to them.

The ranking values may be numerical values. Providing a simple, yet effective, method of ranking the non-selected segments.

The step of presenting at least one non-selected segment may further comprise the step of presenting at least one non-selected segment again having a second predetermined value or having a value within a second predetermined range upon user request.

In this way, the user can further tailor the non-selected segments that they want presented to them. For example, if the segments that were presented having a first predetermined value or having a value within a first predetermined range did not include a certain highlight that the user wishes to view, it is possible for the user to request that the apparatus present segments having a second predetermined value or having a value within a second predetermined range upon user request. The second predetermined value may include more segments than the first predetermined value or the second predetermined range may be larger than the first predetermined range, making it more likely that the highlight the user wishes to view is included.

### BRIEF DESCRIPTION OF DRAWINGS

For a more complete understanding of the present invention, reference is now made to the following description taken in conjunction with the accompanying drawings in which:

FIG. 1 is a simplified schematic of apparatus for presenting a summary of a content item according to an embodiment of the present invention;

FIG. 2 is a flowchart of a method of presenting a summary of a content item according an embodiment of the present invention; and

FIGS. 3a-d is a simplified schematic of an example of an implementation of the apparatus of FIG. 1.

### DETAILED DESCRIPTION OF EMBODIMENTS OF THE INVENTION

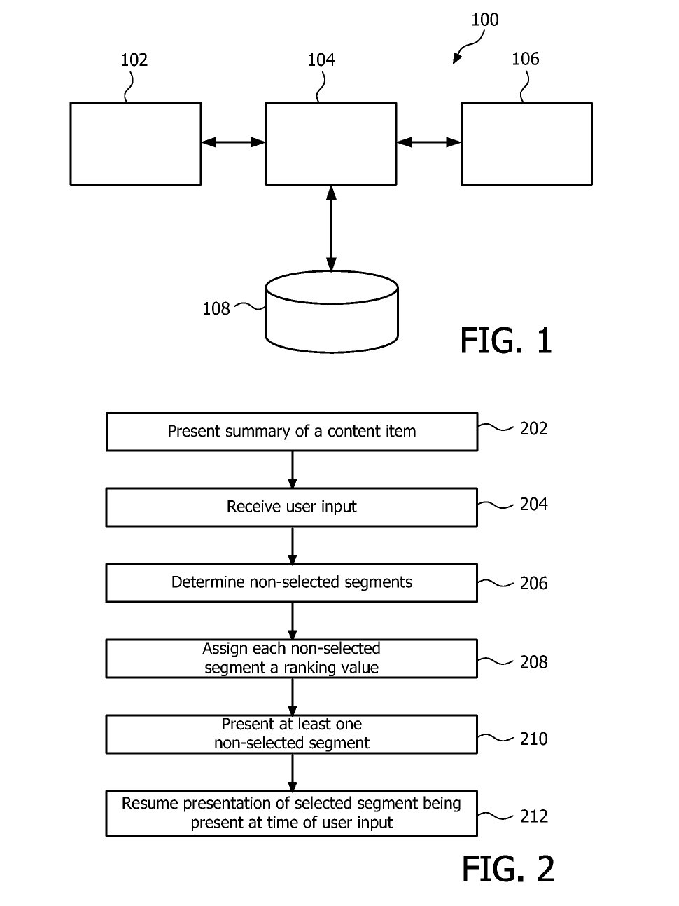

With reference to FIG. 1, the apparatus 100 comprises an interface means 102, such as a remote control having a plurality of push buttons for user selection. The interface means 102 communicates with a processor 104. The output of the processor 104 is connected to the input of a presentation means 106, such as a display screen or television set, for example. The processor 104 is connected to a storage means 108.

Operation of the apparatus of FIG. 1 will now be described in detail with reference to FIG. 2. The presentation means 106 presents a summary of a content item to a user (step 202). The summary comprises a plurality of selected segments (e.g. highlights) of a content item. The summary may be generated automatically using known techniques. The content item and selected segments are stored in the storage means 108 for future recall.

The processor 104 receives a user input via the interface means 102 (step 204). The input may be, for example, a user pressing an “auto-rewind” button on the interface means 102. The presentation means 106 may present a visual indication of the button that the user should press on the interface means 102 to enable the auto-rewind function. This visual indication may be disabled when auto-rewind is being performed. When the user input is received by the processor 104, the processor 104 recalls, from the storage means 108, the segment (i.e. highlight) that was being presented to the user at the time of receiving the user input and the previously presented segment (i.e. the last highlight watched by the user). The processor 104 then determines the non-selected segments located between the previously presented segment and the segment being presented at the time of receiving the user input (step 206).

The processor 104 assigns each non-selected segment located between the previously present segment and the segment being presented at the time of receiving the user input a ranking value based on the user's level of interest (step 208). The ranking values may be, for example, numerical. The processor 104 automatically detects and offers the location of “interesting” segments, i.e. segments that have a particular ranking value. For example, in the case of a numerical scale, segments are ranked from 1 to a finite number N (where N>1). The segments that are ranked as 1 correspond to “the most interesting segments” and the segments that are ranked as N correspond to “the least interesting but still relevant” segments.

Optionally, the processor 104 may assign the ranking value for each non-selected segment beforehand. For example, in the case where the processor 104 analyses the content item before the presentation means 106 presents the summary. In this case, the processor 104 analyses the content item and assigns a ranking value to all the segments. When a user presses the “auto-rewind” button on the interface means 102, the processor 104 needs only to select the segments with a ranking >C, where C is the maximum ranking value of the set of currently selected segments (i.e. the segments included in the summary that the user is watching).

The processor 104 chooses at least one non-selected segment, or any number of non-selected segments, and forwards the chosen non-selected segments to the presentation means 106. The presentation means 106 presents the chosen non-selected segments to the user (step 210). The presentation means 106 may present a visual indicator to indicate the location of the chosen non-selected segments before the presentation means 106 actually presents the non-selected segments to the user. The presentation means 106 may also present an icon indicating that a rewind is ongoing and an icon to undo the automatic rewind. The presented non-selected segments may be, for example, the first segment after the previously presented segment.

Alternatively, the processor 104 chooses the non-selected segments on the basis of the assigned ranking values. For example, the processor 104 chooses one or a number of non-selected segments having a first predetermined value or having a value within a first predetermined range. The processor 104 forwards the chosen non-selected segments to the presentation means 106 and the presentation means 106 presents the chosen non-selected segments to the user (step 210).

In this way, the processor 104 achieves several summarization levels. For example, the lowest level of summarization corresponds to the processor 104 choosing only the non-selected segments with a ranking value of 1 (i.e. the most interesting segments). In this case, the presentation means 106 presents the least amount of non-selected segments to the user. Successive levels of summarization correspond to the processor 104 choosing all non-selected segments with a ranking value within the range of between 1 and M (where 1<M<N). The maximum level of summarization corresponds to the processor 104 choosing all non-selected segments, from all ranks i.e. including those segments with the highest ranking value N. In this case, the presentation means 106 presents all of the non-selected segments located between the previously presented segment and the segment being presented at the time of receiving the user input.

Upon user request, the presentation means 106 presents at least one non-selected segment again having a second predetermined value or having a value within a second predetermined range.

After presentation of the non-selected segments, the presentation means 106 resumes presentation of the selected segments being presented at the time of receiving said user input (step 212). In other words, when the auto-rewind play is over, the presentation means 106 resumes play from the point where the user enabled the automatic rewind function. While the presentation means 106 resumes playback from that point, the processor 104 returns the summarization level to the original state (i.e. the state that it was at when the user pressed the auto-rewind button).

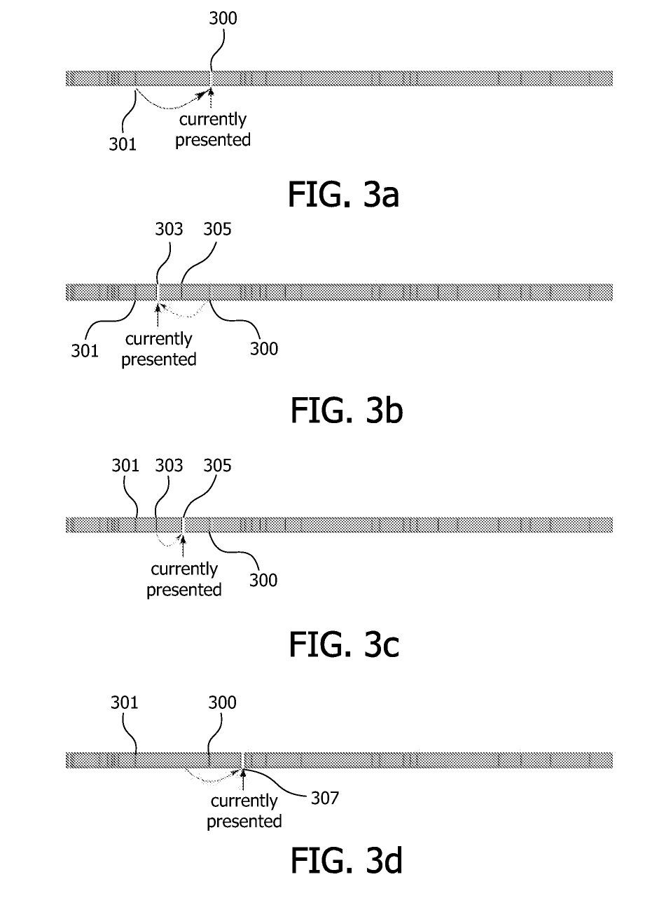

With reference to FIGS. 3a-3d, a specific example of an implementation of the invention is shown. The Figures illustrate a timeline representing the same content item. The content item comprises a plurality of segments (or highlights) indicated by the vertical lines 300, 301, 303, 305, 307 which are presented to a user in a summary. In this case, while watching a highlight (segment) on the lowest summarization level, as shown in FIG. 3a the user finds that the presentation means 102 in showing segment 301, 300 failed to show a desired highlight (for example a goal) at that level.

The interface means 102 receives a user input by the user pressing an “auto-rewind” button and the processor 104 temporarily increases the summarization level to its maximum to make sure that the desired highlight will be shown, as such segments 301, 303, 305 and 300 are presented as shown in FIG. 3b instead of the two segments 301, 300. Therefore, the processor 104 rewinds the summarization and the presentation means 106 plays back the first segment 303 that was not watched by the user before the current segment 300.

Since there are two segments 303, 305 available between the previous segment 301 and the current segment 300, the presentation means 106 now plays the second segment 305 that was not watched by the user, as illustrated in FIG. 3c.

After finishing playing that segment 305, the presentation means 106 resumes play at the segment 300 that the user was watching when the auto-rewind button, as illustrated in FIG. 3d and proceed to present segment 307. The processor 104 lowers the summarization level back to the original level before the user pressed the auto-rewind button.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method of presenting a summary of a content item, said summary comprising a plurality of selected segments (301, 300) of said content item, the method comprising the steps of:
presenting (202) said summary to a user;
receiving (204) a user input;
presenting (210) at least one non-selected segment (303, 305) located between a previously presented segment (301) and the segment (300) being presented at the time of receiving said user input.

2. A method according to claim 1 further comprising the step of: resuming presentation (212) of said selected segment (300) being presented at the time of receiving said user input, after presentation of said at least one non-selected segment (303, 305).

3. A method according to claim 1, wherein the step of presenting at least one non-selected segment comprises the steps of:
presenting a first non-selected segment (303) located after the previously presented segment; and
presenting at least one subsequent non-selected segment (305) located between the presented first non-selected segment and the segment being presented at the time of receiving said user input.

4. A method according to claim 1, wherein the step of presenting at least one non-selected segment (303, 305) comprises the steps of:
assigning (208) each non-selected segment (303, 305) of said content item a ranking value based on the user's level of interest;
presenting (210) at least one non-selected segment having a first predetermined value or having a value within a first predetermined range.

5. A method according to claim 4, wherein the ranking values are numerical.

6. A method according to claim 4, wherein the step of presenting at least one non-selected segment (303, 305) further comprising the step of:
presenting at least one non-selected segment again having a second predetermined value or having a value within a second predetermined range upon user request.

7. A computer program product comprising a plurality of program code portions for carrying out the method according to claim 1.

8. Apparatus for presenting a summary of a content item, said summary comprising a plurality of selected segments (301, 300) of said content item, the apparatus comprising the steps of:
means for presenting (106) said summary to a user;
interface means (102) for receiving a user input;
means for presenting (106) at least one non-selected segment (303, 305) located between a previously presented segment (301) and the segment (300) being presented at the time of receiving said user input.

9. Apparatus according to claim 8 further comprising:
means for resuming presentation (106) of said segment (300) being presented at the time of receiving said user input, after presentation of said at least one non-selected segment (303, 305).
